(19) United States
(12) Patent Application Publication
(10) Pub. No.: US 2003/0127547 A1
(43) Pub. Date: Jul. 10, 2003

(54) Fuel injection valve

(76) Inventor: Detlef Nowak, Untergruppenbach (DE)

Correspondence Address: KENYON & KENYON, ONE BROADWAY, NEW YORK, NY, 10004, US

(21) Appl. No.: 10/182,409

(22) PCT Filed: Nov. 26, 2001
(86) PCT No.: PCT/DE01/04403

(30) Foreign Application Priority Data
Nov. 28, 2000 (DE) 100 59 007.1

(51) Int. Cl. B05B 1/00

(52) U.S. Cl. 239/596

(57) ABSTRACT

A fuel injector (1) for fuel injection systems of internal combustion engines includes a valve needle (3) and a valve closing body (4) which is mechanically linked thereto and cooperates with a valve seat surface (6) situated in a valve seat body (5) to form a sealing seat, and having a plurality of discharge orifices (7), which are introduced in a spray-orifice disk (31), which is situated downstream from the sealing seat on the fuel injector (2). The spray-orifice disk (31) has a dome-shaped convexity (37) at least in the area of the discharge orifices (7), which is oriented against the direction of flow of the fuel and the discharge orifices (7) are arranged in a spiral on the dome-shaped convexity (37) of the spray-orifice disk (31).

### BACKGROUND INFORMATION

The present invention is directed to a fuel injector according to the definition of the species in the main claim.

Fuel injectors which discharge fuel from a plurality of discharge orifices are known, for example, from German Patent Application 198 27 219 A1. They have a jet adjusting plate, which is situated at the downstream end of the fuel injector and has a plurality of discharge orifices. The discharge orifices are subdivided into two groups, which are arranged in two hole circles having different diameters. The central axes of the discharge orifices in one group are on a conical surface, the cones opening in the downstream direction. The cone which is associated with the central axes of the discharge orifices of the hole circle having the larger diameter has a greater apex angle than the cone on whose lateral surface the central axes of the discharge orifices of the inner hole circle are situated, so that the conical surfaces have no line of intersection and the individual partial fuel jets do not collide with one another.

The jet adjusting plate may be designed with a convex geometry curving toward the outside of the fuel injector. The discharge orifices are situated in the convex area, so that the discharged fuel moves away from the central axis of the fuel injector along the jet path.

Furthermore, fuel injectors having a plurality of discharge orifices are known from German Patent Application 198 04 463 A1. They have a conical downstream end of the fuel injector, in which two rows of discharge orifices are arranged. Due to the conical geometry of the downstream end of the fuel injector, the fuel jets are oriented away from the central axis during the discharge operation. The individual partial jets are arranged on one or more conical surfaces.

The use of at least one perforated disk situated at the downstream end of the fuel injector, which is curved toward the upstream end is known from U.S. Pat. No. 5,484,108. The valve closing body has a central recess downstream from the sealing seat, through which the fuel flows to orifices in a first perforated disk when the fuel injector is open. At least the first of the at least two perforated disks through which the fuel flows has a shape such that part of the disk protrudes into the recess in the valve closing body. Downstream a volume is formed between the first and the subsequent perforated disk. Using a plurality of perforated disks, swirl production is separated from fuel metering. Thus, for example, swirl may be produced when the fuel flows through the upstream disk. The flow becomes homogenized in the volume between the two perforated disks, and the fuel is discharged in accurately metered amounts.

The disadvantage with U.S. Pat. No. 5,484,108 is a large dead volume downstream from the sealing seat. A large amount of fuel is held back after the end of the discharge due to the formation of a volume upstream from the metering orifices in the second perforated disk. This amount of fuel may enter the combustion chamber with a delay due to evaporation. Harmful emissions increase considerably along with the resulting rise in gasoline consumption.

A further disadvantage in using a plurality of disks is the limited variability in the geometric design of the jet direction of the fuel to be discharged. Forming the first perforated disk in the recess of the valve seat body, the possible upstream convexity of the second perforated disk is very limited radially. Thus, the arrangement of the discharge orifices is limited to simple geometries if collision of the individual jets is to be avoided.

The fuel injectors described in German Patent Application 198 27 219 A1 and German Patent Application 198 04 463 A1 have the disadvantage that the mixture becomes leaner in the central axis area due to the discharge of the fuel away from the central axis. Although a more uniform mixture formation in the central axis area may be achieved by reducing the apex angle, however, the penetration depth into the combustion chamber increases simultaneously, whereby the injected fuel may more easily get into contact with the piston. In addition to undesirable combustion-related effects due to wall losses, the life of the piston is reduced due to the combustion of fuel on its surface.

The fuel injector known from German Patent Application 198 04 463 A1 also has the disadvantage of a thick-walled design in the area of the discharge orifices. The single-piece design of the downstream end,and of the fuel injector housing requires thicker walls. The corresponding manufacturing technologies to be used for introducing the discharge orifices are expensive, since the small diameter of an individual discharge orifice cannot be punched if the wall thickness is great.

### ADVANTAGES OF THE INVENTION

By contrast, the single injection orifice plate whose dome-shaped convexity is oriented upstream is advantageous in the fuel injector according to the present invention. Due to this measure, the fuel jets may be arranged on the lateral surface of a double cone. Despite a large apex angle, the fuel mixture does not become leaner in the area of the fuel injector's central axis. The focus of the discharged fuel is in the combustion chamber rather than in the fuel injector.

A further advantage is the large available surface compared with U.S. Pat. No. 5,484,108, which allows a larger number of discharge orifices to be arranged in the dome-shaped convexity without the widths of the webs between the discharge orifices becoming so narrow that mechanical stability is critically reduced. The discharge orifices may be arranged along a spiral whose radial dimension is significantly enlarged.

In contrast to the single-piece design of the fuel injector known from German Patent Application 198 27 219 A1, the fuel injector according to the present invention has the advantage that the material of the spray-orifice disk undergoes reinforcement in the molding process, for example, via cold molding. This allows thinner materials to be used for the spray-orifice disk, which in turn simplifies the introduction of discharge orifices and the fastening of the spray-orifice disk to the fuel injector. Manufacturing costs are reduced.

In addition, variants are simply formed in an advantageous manner. Both fuel metering and the discharge pattern are adjustable by installing a different spray-orifice disk. This allows cost effective adjustments to customer requirements, while using mostly identical parts.

It is furthermore advantageous that, when off-dimension discharge orifices are detected, only an inexpensive punch-bent part is rejected. The housing body, which is considerably more expensive to manufacture, may continue to be used.

Advantageous refinements of the fuel injector according to the present invention are possible through the measures recited in the subclaims.

For example, by arranging the discharge orifices along a spiral, the fuel is dischargeable asymmetrically in a controlled manner. The individual fuel jets do not collide, since the discharge orifices are arranged so that each fuel jet passes between two fuel jets of the opposite discharge orifices. Particularly advantageous in the case of an asymmetrical discharge pattern is the possibility of adjusting the spray direction to special requirements which arise due to the relative position of the spark plug and fuel injector.

It is advantageous when an appropriate manufacturing method is used for the spray-orifice disk, to introduce the discharge orifices prior to molding the disk. This allows the introduction of the discharge orifices in a flat disk using simple and cost effective techniques such as punching them into the spray-orifice disk. The disc material is not yet hardened. This makes a long service life of the punching tool possible despite the small orifice diameter. Reinforcement, along with additional shape stability such as achieved by cold molding, for example, is only introduced in the material in a second step. Thus, even thin walled components are well-suited for use at high fuel pressures.

In addition, the thin walls considerably simplify attachment to the nozzle body or the valve seat body. Techniques that are simple to use with thin materials may be employed. In particular, laser welding offers advantages regarding processing speed and reproducibility.

### DRAWING

An embodiment of the present invention is schematically illustrated in the drawing and explained in more detail in the description that follows.

FIG. 1 shows a schematic partial section through an exemplary embodiment of a fuel injector according to the present invention;

FIG. 2 shows a schematic partial section in detail II of FIG. 1 through the exemplary embodiment of the fuel injector according to the present invention;

FIG. 3 shows a top view of a first exemplary embodiment of a spray-orifice disk of a fuel injector according to the present invention; and

FIG. 4 shows the angular condition for the arrangement of the discharge orifices of the exemplary embodiment.

### DETAILED DESCRIPTION OF THE EXEMPLARY EMBODIMENT

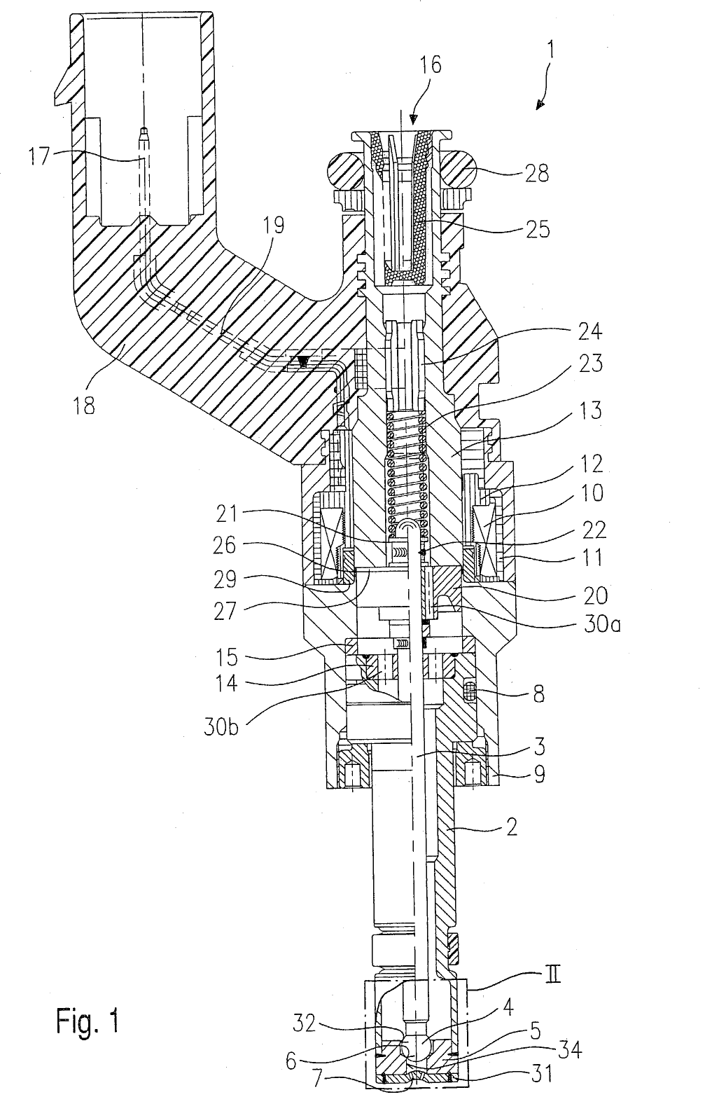

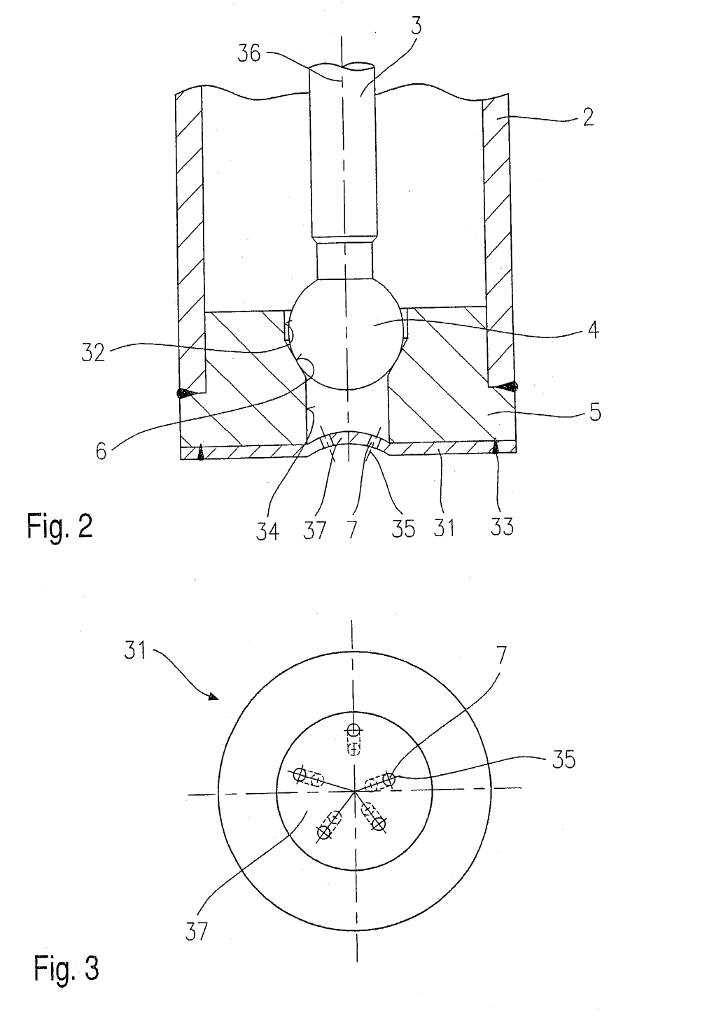

Before describing an exemplary embodiment of fuel injector 1 according to the present invention with reference to FIGS. 2 through 4, for better understanding the essential components of fuel injector 1 according to the present invention shall be briefly presented in general with reference to FIG. 1.

Fuel injector 1 is designed in the form of a fuel injector 1 for fuel injection system of internal combustion engines having mixture compression and spark ignition. Fuel injector 1 is suitable in particular for direct injection of fuel in a combustion chamber (not shown) of an internal combustion engine.

Fuel injector 1 includes a nozzle body 2, in which a valve needle 3 is situated. Valve needle 3 is mechanically linked to a valve closing body 4, which cooperates with a valve seat surface 6 situated on a valve seat body 5 to form a sealing seat. Fuel injector 1 is an electromagnetically actuated fuel injector 1 in this embodiment, which has at least one discharge orifice 7. Nozzle body 2 is sealed against the external pole of a solenoid 10 by a seal 8. Solenoid 10 is encapsulated in a housing 11 and wound onto a bobbin 12, which is in contact with an internal pole 13 of solenoid 10. Internal pole 13 and external pole 9 are separated by a gap 26 and are supported by a connecting part 29. Solenoid 10 is excited via a line 19 by an electric current suppliable via an electrical plug-in contact 17. Plug-in contact 17 is surrounded by a plastic sheath 18, which may be extruded on internal pole 13.

Valve needle 3 is guided in a disk-shaped valve needle guide 14, which is associated with an adjusting disk 15 used to adjust the valve needle lift. On the upstream end of adjusting disk 15 there is an armature 20, which is non-positively connected to valve needle 3 via flange 21. Valve needle 3 is connected to flange 21 by weld 22. A restoring spring 23, which in the present embodiment of fuel injector 1 is pre-stressed by a sleeve 24 pressed into internal pole 13, is supported by flange 21.

Fuel channels 30a, 30b run in valve needle guide 14 and armature 20. A filter element 25 is situated in a central fuel feed 16. Fuel injector 1 is sealed relative to a fuel line (not shown) by a seal 28.

In the idle state of fuel injector 1, armature 20 is acted upon by restoring spring 23 via flange 21 on valve needle 3 against its lift direction so that valve closing body 4 is held in sealing contact on valve seat surface 6. When solenoid 10 is energized, it forms a magnetic field which moves armature 20 against the elastic force of restoring spring 23 in the direction of lift, the lift being defined by a working gap 27 between internal pole 13 and armature 20. Armature 20 entrains flange 21, which is welded to valve needle 2, and thus also valve needle 3 in the direction of lift. Valve closing body 4, which is mechanically linked to valve needle 3, is lifted from valve seat surface 6, fuel flows in a central recess 32 on valve closing body 4 into a passage 34 in valve seat body 5 and is discharged through discharge orifices 7 in a spray-orifice disk 31.

If the solenoid current is switched off, after the magnetic field has sufficiently decayed, armature 20 drops off internal pole 13 due to the pressure of restoring spring 23 onto flange 21, causing valve needle 3 to move against the direction of lift. This makes valve closing body 4 come to rest on valve seat surface 6, and fuel injector 1 is closed.

FIG. 2 shows an exemplary embodiment in which spray-orifice disk 31 is secured on the downstream surface of valve seat body 5 by a weld 33. Weld 33 may be produced by laser welding, for example. Spray-orifice disk has a central dome-shaped convexity 37, whose radial dimension preferably corresponds to the radial dimension of passage 34 through which discharge orifices 7 are supplied with fuel when fuel injector 1 is open. Dome-shaped convexity 37 is oriented upstream, whereby the dead volume located downstream from valve closing body 4 inside passage 34 is reduced. The dimensional stability against the dynamic pressure of the fuel when fuel injector 1 is open is greater than in the case of a flat spray-orifice disk 31.

In order to direct the discharged fuel in individual fuel jets, a plurality of discharge orifices 7 are made in spray-orifice disk 31, which are inclined with respect to central axis 36 of fuel injector 1 at the same angle or at different angles. They are introduced into spray-orifice disk 31 in the area of dome-shaped convexity 37, and their maximum radial dimension is less than the radial dimension of passage 34 in valve seat body 5. Discharge orifices 7 are preferably introduced in spray-orifice disk 31 by punching prior to molding. In order to achieve a certain discharge pattern, it may be advantageous to use a punching angle other than 90°. Instead of the cylindrically punched discharge orifices 7, conically widening or tapering discharge orifices 7 in the direction of the fuel flow may also be advantageous.

The amount of fuel to be discharged that is metered is defined by the cross sections of discharge orifices 7 in spray-orifice disk 31. When fuel injector 1 is fully open, they form the smallest cross section area for the passage of fuel, so that throttling to limit the flow rate only takes place in spray-orifice disk 31.

Instead of the annular gap illustrated in FIG. 2, which is formed between valve closing body 4 and central recess 32, fuel channels opening in valve seat surface 6 upstream from the sealing seat may also be introduced in valve seat body 5. In this case, the radial dimension of central recess 32 corresponds to the radial dimension of valve closing body 4, so that valve closing body 4 is guided in central recess 32. The cross section of the fuel channels introduced in central recess 32, for example, in the form of grooves must in turn be considerably greater than the sum of cross sections of discharge orifices 7 in spray-orifice disk 31.

One example of the arrangement of discharge orifices 7 on spray-orifice disk 31 is illustrated in FIG. 3. Discharge orifices 7 are arranged along a spiral. Central axes 35 of discharge orifices 7 are oriented so that their extension in the direction of discharge intersects central axis 36 of fuel injector 1. If central axes 35 of discharge orifices 7 have the same inclination relative to central axis 36 of fuel injector 1, central axes 35 of discharge orifices 7 intersect central axis 36 of fuel injector 1 at different distances from the downstream end of fuel injector 1. In order to prevent collisions, which would still occur in the case of a symmetrical arrangement between opposite discharge orifices 7 with respect to central axis 36 of fuel injector 1, discharge orifices 7 are distributed along the spiral so that no other discharge orifice 7 is situated opposite any discharge orifice 7.

Discharge orifices 7 may be introduced in spray-orifice disk 31 so that central axes 35 of discharge orifices 7 do not intersect central axis 36 of fuel injector 1. The fuel distribution in the area of central axis 36 of fuel injector 1 may be set by varying the minimum distance of central axes 35 of discharge orifices 7 from central axis 36 of fuel injector 1.

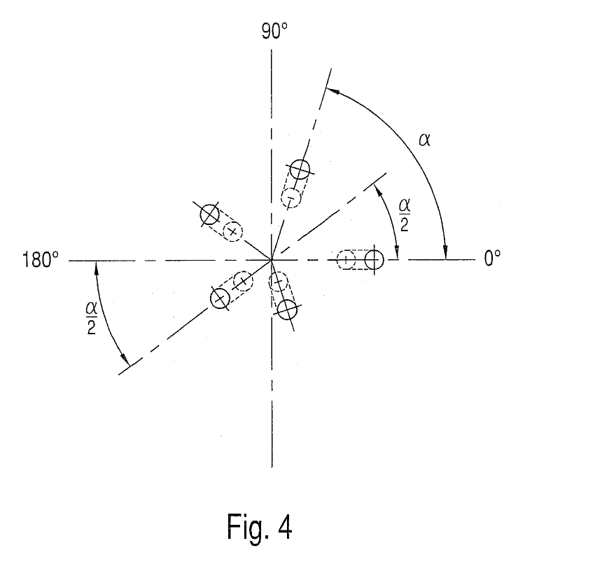

For the arrangement of discharge orifices 7 according to FIG. 3, this condition for a constant angular distribution of discharge orifices 7 is illustrated in FIG. 4. Angle α is obtained from the requirement nα=180°+α/2, if the nth discharge orifice is to be arranged opposite the gap between the 0^{th} and the 1^{st} discharge orifice. For α=360°/(2n−1), this yields the distribution of (2n−1) discharge orifices 7 at a constant angle α.

In order to achieve a discharge pattern that is inclined relative to central axis 36 of fuel injector 1, the central point of the spiral along which discharge orifices 7 are arranged may be situated outside central axis 36 of fuel injector 1. For the arrangement along a spiral, locating the center of the spiral outside the center of dome-shaped convexity 37 of spray-orifice disk 31 is also possible.

What is claimed is:

1. A fuel injector (1) for fuel injection systems of internal combustion engines having a valve needle (3) and a valve closing body (4) which is mechanically linked to valve needle (3) and cooperates with a valve seat surface (6) situated in a valve seat body (5) to form a sealing seat, and having a plurality of discharge orifices (7) introduced in a spray-orifice disk (31), which is situated downstream from the sealing seat on the fuel injector (1), and, at least in the area of the discharge orifices (7), has a dome-shaped convexity (37) which is oriented oppositely to the direction of flow of the fuel, wherein the discharge orifices (7) are positioned in a spiral on the dome-shaped convexity (37) of the spray-orifice disk (31).

2. The fuel injector according to claim 1,
wherein the dome-shaped convexity (37) protrudes into a central recess (32) of the valve seat body (5).

3. The fuel injector according to claim 1 or 2,
wherein in a projection of the central axes (35) of the discharge orifices (7) onto a plane perpendicular to the central axis (36) of the fuel injector (1), the distance of the central axes (35) of the discharge orifices (7) from the central axis (36) of the fuel injector (1) is such that the individual fuel jets do not intersect.

4. The fuel injector according to one of claims 1 through 3,
wherein, in a projection of the central axes (35) of the discharge orifices (7) onto a plane perpendicular to the central axis (36) of the fuel injector (1), the central axis (35) of each discharge orifice (7) divides the angle formed between two central axes (35), of adjacent discharge orifices (7) disposed oppositely to each other relative to the central axis (36) of the fuel injector (1), into two halves.
